(19) United States
(12) Patent Application Publication
(10) Pub. No.: US 2020/0103309 A1
(43) Pub. Date: Apr. 2, 2020

(54) Historical Playback of Waveform Data

(71) Applicant: Computational Systems, Inc., Knoxville, TN (US)

(72) Inventor: Patrick P. Slavick, Alcoa, TN (US)

(73) Assignee: Computational Systems, Inc., Knoxville, TN (US)

(21) Appl. No.: 16/571,336

(22) Filed: Sep. 16, 2019

Related U.S. Application Data
(60) Provisional application No. 62/738,181, filed on Sep. 28, 2018.

(51) Int. Cl. G01M 13/00; G01H 13/00

(52) U.S. Cl. CPC G01M 13/00; G01H 13/00

(57) ABSTRACT

A method for continuous playback of machine vibration data that is stored in a plurality of data files, by selecting for analysis desired ones of the plurality of data files, retrieving a first one of the desired data files, and designating the first of the desired data files as a current data file. A sequence of derived measurements is calculated, based on a subsampling of the current data file, and visualizations of the current data file and the sequence of derived measurements are presented. A subsequent one of the desired data files is retrieved, and the subsequent one of the desired data files is designated as the current data file. These steps are iteratively repeated until all of the desired data files have been processed. Selected portions of the derived measurements are stored on a non-transitory computer-readable storage medium.

This application claims all rights and priority on prior pending United States provision patent application Ser. No. 62/738,181 filed 2018 Sep. 28, the entirety of which is included herein by reference. This invention relates to the field of machine condition monitoring. More particularly, this invention relates to the continued playback of discrete files of machine vibration data.

### BACKGROUND

### Field

Machine health science involves collecting data in regard to the operation or other conditions of the machine, such as vibration, temperature, and alignment, and then using that data to either detect current problems with the operation of the machine, or predict future problems with the machine.

Manual methods of machine health monitoring require a technician to walk through an industrial facility, temporarily attach sensors or monitors to machines, record data associated with each machine for a given length of time, and then move on to the next machine. Methods such as these are inherently incapable of providing continuous data in regard to any given machine, because the technician only spends a finite amount of time with each machine. Thus, the collected data for a given machine tends to exist as a collection of discrete files residing in a central file repository, each of which represents only a few minutes or so of machine operation.

Online monitoring systems are more permanently mounted to each machine. Some online systems store collected data for a user-defined length of time and at a user-defined time interval. For instance, an online monitoring system might collect data from a machine for one minute every five minutes, and store each instance of collected data as a separate file. One reason for such intermittent data collection is that the amount of data collected for vibration analysis tends to be quite large, and thus requires large amounts of both transmission bandwidth and data storage space, which some systems are not able to provide. Thus, this method again tends to produce relatively small, discrete data files.

Other online monitoring systems are able to continuously collect data in regard to the machine. The collected data for a given machine tends to reside in large files in the central file repository, each of which holds data that represents many hours (for example) of machine operation. This is ideal for those systems that are able to accommodate the bandwidth and storage requirements of these large files.

In order to analyze the data that is collected, regardless of the method by which that data was collected, a given data file is retrieved from the repository and loaded into a computerized analysis program. Once in the analysis program, the data, such as vibration data, is presented on a display as a visualized waveform that is played back and changes over time. As a cursor sweeps down through time along the waveform, various analytics are performed, visualized, and presented on the display along with the waveform.

Such analysis tends to work well for continuously collected data, as the large, hours-long data files tend to provide the engineer with the ability to view large trends in the data over time. Unfortunately, the smaller, discretely-collected data files do not afford the engineer this same ability.

What is needed, therefore, is a system that tends to reduce issues such as those described above, at least in part.

### SUMMARY

These and other needs are met by a method for continuous playback of machine vibration data that is stored in a plurality of data files, by selecting for analysis desired ones of the plurality of data files, retrieving a first one of the desired data files, and designating the first of the desired data files as a current data file. A sequence of derived measurements is calculated, based on a subsampling of the current data file, and visualizations of the current data file and the sequence of derived measurements are presented. A subsequent one of the desired data files is retrieved, and the subsequent one of the desired data files is designated as the current data file. These steps are iteratively repeated until all of the desired data files have been processed. Selected portions of the derived measurements are stored on a non-transitory computer-readable storage medium.

In various embodiments according to this aspect of the invention, the desired ones of the plurality of data files comprise all of the plurality of data files. In various embodiments, the desired ones of the plurality of data files are retrieved in chronological order. In various embodiments, the desired ones of the plurality of data files are retrieved in a user-defined order. In various embodiments, the subsampling of the current data file is performed at a user-defined rate. In various embodiments, the subsampling of the current data file is performed at a computer-defined rate based at least in part upon properties of the current data file. In various embodiments, the derived measurements include at least one of sub-waveform, sub-spectrum, cascade spectrum, and Bode/Nyquist plots.

According to another aspect of the invention, there is described an apparatus for performing the method as described above. In yet another aspect of the invention, there is described a non-transitory, computer-readable storage medium having stored thereon a computer program comprising a set of instructions for causing a computer to continuously playback machine vibration data that is stored in a plurality of data files, by performing the steps of the method as described above.

The foregoing summary is illustrative only and is not intended to be limiting in any way. In addition to the illustrative aspects, embodiments, and features described above, further aspects, embodiments, and features will become apparent by reference to the drawings and the following detailed description.

### DRAWINGS

Other embodiments of the invention will become apparent by reference to the detailed description in conjunction with the figures, wherein elements are not to scale so as to more clearly show the details, and wherein like reference numbers indicate like elements throughout the several views, and wherein:

FIG. 1 depicts components of an apparatus for continuous playback of stored machine vibration data according to an embodiment of the present invention.

FIG. 2 depicts a method for continuous playback of stored machine vibration data according to an embodiment of the present invention.

### DESCRIPTION

Various embodiments of the present invention provide an apparatus or method by which a plurality of data files may be selected for analysis, wherein when analysis on a preceding data file is completed, or in other words, when the end of the data file is encountered, a subsequent selected data file is automatically loaded and the analysis proceeds in an uninterrupted manner. Thus, the problem with the engineer having to repeatedly and manually load a subsequent data file for analysis is alleviated, and the attention of the engineer is freed to concentrate more fully on the analysis of the data.

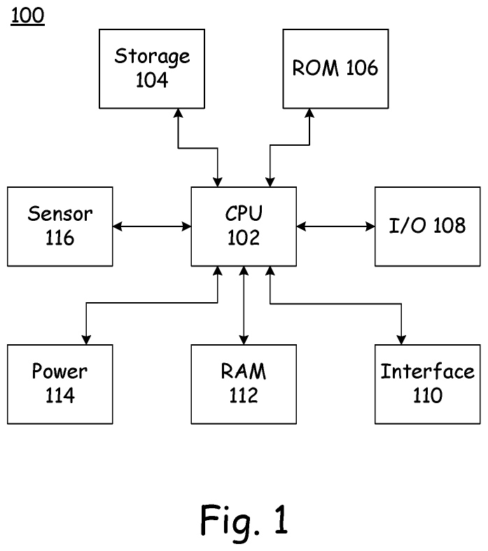

With reference now to FIG. 1, there is depicted one embodiment of a computerized apparatus 100 capable of performing the actions as described herein. The apparatus 100 may be a server, a desktop computer, a special purpose computing device, a tablet computer, a smart phone, or a component level processor. In this embodiment, the apparatus 100 is locally under the control of the central processing unit 102, which controls and utilizes the other modules of the apparatus 100 as described herein. As used herein, the word module refers to a combination of both software and hardware that performs one or more designated function. Thus, in different embodiments, various modules might share elements of the hardware as described herein, and in some embodiments might also share portions of the software that interact with the hardware.

The embodiment of apparatus 100 as depicted in FIG. 1 includes, for example, a non-transitory, computer-readable, data storage medium module 104 such as a hard drive, tape drive, optical drive, or some other relatively long-term data storage device. A read-only memory module 106 contains, for example, basic operating instructions for the operation of the apparatus 100. An input-output module 108 provides a gateway for the communication of data and instructions between the apparatus 100 and other computing devices, networks, or data storage modules. An interface module 110 includes, for example, keyboards, speakers, microphones, cameras, displays, mice, and touchpads, and provides means by which the engineer can observe and control the operation of the apparatus 100.

A random-access memory module 112 provides short-term storage for data that is being buffered, analyzed, or manipulated and programming instructions for the operation of the apparatus 100. A power module 114 is also provided in various embodiments of the apparatus 100. In some embodiment that power module 114 is a portable power supply, such as one or more batteries. In some embodiments the power module 114 includes a renewable source, such as a solar panel or an inductive coil that are configured to provide power or recharge the batteries. In other embodiments the power module 114 receives power from an external power source, such as a 110/220 volt supply.

Some embodiments of the apparatus 100 include a sensor 116, which senses at least one of various aspects of machine health, such as vibration. In some embodiments the steps of the method as described herein are embodied in a computer language on a non-transitory, computer-readable, data storage medium that is readable by the apparatus 100 of FIG. 1, and that enables the apparatus 100 to implement the process as described herein.

In some embodiments the sensor 116 is configured to monitor at least one of at least machine displacement, velocity, and acceleration. In various embodiments, the vibration sensor 116 may be at least one of a microelectromechanical system sensor, piezoresistive sensor, piezoelectric sensor, electromagnetic sensor, laser-displacement sensor, and an acoustic sensor. As will be appreciated, the vibration sensor 116 is not limited to a particular mode of collecting machine vibration data. Vibration data generally refers to the data collected by the vibration sensor 116, and characteristics of the data may vary based on the sensor 116 that is used in a particular embodiment.

In some embodiments the sensor 116 is not provided as a part of the apparatus 100, but instead the apparatus 100 receives all of the data to be analyzed through the I/O module 108, stores it in the storage module 104, and performs analytics on the data in the RAM module 112. As introduced above, the data is stored in data files, some of which might represent data capture periods that are relatively brief.

In one embodiment, the vibration sensor 116 collects the waveform data based on instructions from the computer 100. The instructions may include a collection period (the length of time during which data is collected) and a collection interval (the length of time between the data collection periods, when no data is collected). The collection period and the collection interval may be pre-determined default values, user selected values, or determined based on analysis of the waveform data.

For example, an engineer may input, via interface 110, a collection period of 0.2 seconds and a collection interval of one minute, and the computer 100 may then instruct the sensor 116 to collect the waveform data based on the input values. The computer 100 may receive the collected data from the vibration sensor 116 and store each instance as a separate data file in the memory module 112 or the storage module 104.

According to some embodiments, the computer 100 may be configured to instruct the vibration sensor 116 to collect waveform data in bursts and retrieve a portion of the waveform data from the vibration sensor 116 immediately following collection. The computer 100 may then proceed to analyze the waveform as discussed below, and upon completing the analysis or nearing the end of the analysis of the waveform, the computer 100 may instruct the vibration sensor 116 to collect another burst of waveform data for subsequent analysis.

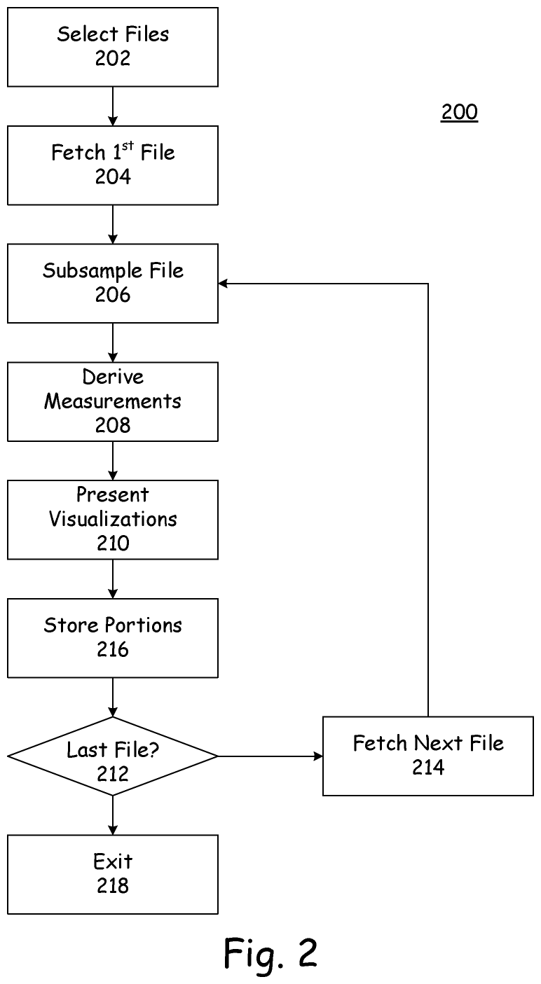

With reference now to FIG. 2, there is provided a flow chart of a method according to an embodiment of the present invention. The processor 102 receives a request to analyze the waveforms stored in the discrete data files, which request may be generated by an engineer through the interface module 110, as given in block 202. For example, the engineer may initialize analysis software or may navigate to the stored data files using a file explorer display of the interface module 110, and open one or more of the stored data files. The request may include a selection of a group of data files from the stored data files. For example, a user may only be interested in analyzing a subset of the collected data files and may select the desired data files from the stored data files. In other instances, a selection may not occur, and the processor 102 may automatically select all of the stored data files, such as all of the stored data files within a given subdirectory, or all of the stored data files that meet certain criteria specified by the engineer.

The processor 102 may retrieve the first selected data file from the storage module 104, as given in block 204, based on a chronological order, a reverse chronological order, or a user-defined order of the selected waveforms. The engineer may select data files and place them in a desired order for playback by the system 100. The processor 102 may then continuously retrieve and analyze the data files without further input until each selected data file has been analyzed and visualized in the user-specified order as discussed below.

The first selected data file is subsampled, as given in block 206. Subsampling in one embodiment comprises dividing the waveform within the data file into segments to calculate different values. The processor 102 subsamples the waveform at a user-defined rate, a default rate, or at a determined rate. The subsampling rate in one embodiment is defined by a number of datapoints processed per second.

The processor 102 calculates a series of derived measurements based on the subsampling of the waveform, as given in block 208. For example, the processor 102 calculates various spectra or characterizations of the waveform in the data file, such as sub-spectrum, cascade spectrum, and frequency response to be plotted on Bode/Nyquist plots among other calculations.

As the processor 102 sweeps through the current data file, subsampling and calculating derived measurements, the processor 102 generates visualizations of both the waveform in the data file and the derived measurements, and provides the visualizations to be presented through the interface module 110, such as on a display, as given in block 210. The visualizations may include basic spectral plots, cascade spectrum plots, Bode/Nyquist plots, as well as waveform plots, that may include a cursor position of the current position of analysis. The waveform plots may include a playback plot of all of the waveforms in the selected data files, a plot of the waveform currently being analyzed, or subplots of the waveform currently being analyzed, such as the portion of the waveform being sub sampled.

The processor 102 may also analyze more than one waveform at once, and calculate dual-waveform measurements, such as orbit, full spectrum, cascade full spectrum, and shaft centerline measurements, and generate corresponding visualizations. The processor 102 may also compare the waveforms and calculated measurements to generate predictions about the health of the machine. For example, the processor 102 may compare a current waveform to a waveform previously collected from the same machine or other historical data (e.g. a waveform collected days or weeks ago).

The processor 102 may subsample the waveforms, calculate derived measurement and dual-waveform measurements, and make a prediction about the health of the machine based on a comparison of the derived measurements, the dual-waveform measurements, or both. The processor 102 may then produce a notification summarizing the prediction and any pertinent information, such as the calculated measurements and reasoning behind the prediction, on the display device of the interface module 110. For example, the processor 102 may identify a resonant frequency in the current waveform that was not present in the previously collected waveform, predict a loose part or instability, and generate a notification.

At any point during the process, such as given in block 216, the engineer can pause the playback and select elements such as analyses and visualizations of the combined waveform for storage in the non-transient, computer-readable storage medium module 104, such as for later reference for either manual or automatic predictive capabilities.

As the processor 102 approaches the end of the first data file, the processor 102 checks to see if any other data files have been queued for analysis, or if the currently-processed data file is the last data file to be processed, as given in block 212. If the current data file is not the last data file to be analyzed, then the processor 102 retrieves the next subsequent data file from the storage module 104, and starts the analysis of the subsequent—now current—data file, as given in block 206.

In this manner, the processor 102 automatically retrieves and analyzes subsequent data files until the processor 102 reaches the end of the final selected data file, all of which results in a continuous playback of the waveforms in the selected data files.

While the processor 102 analyzes the selected waveforms, the engineer customizes various aspects of the analysis. The engineer can stop and start the analysis, scrub along the waveform currently being analyzed by moving a cursor, and skip or rewind to subsequent or previous waveforms. The engineer may also select which visualizations are displayed and may customize the size or color of the visualizations. The engineer may add or remove waveforms from the selection during the analysis. If all of the selected data files have been processed, as determined in block 212, then the program exits as given in block 218.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for continuous playback of machine vibration data that is stored in a plurality of data files, the method comprising the steps of:
a) selecting for analysis desired ones of the plurality of data files,
b) retrieving a first one of the desired data files and designating the first of the desired data files as a current data file,
c) calculating a sequence of derived measurements based on a subsampling of the current data file,
d) presenting visualizations of the current data file and the sequence of derived measurements,
e) retrieving a subsequent one of the desired data files and designating the subsequent one of the desired data files as the current data file,
f) iteratively repeating steps (c), (d), and (e) until all of the desired data files have been processed, and
g) storing selected portions of the derived measurements on a non-transitory computer-readable storage medium.

2. The method of claim 1, wherein the desired ones of the plurality of data files comprise all of the plurality of data files.

3. The method of claim 1, wherein the desired ones of the plurality of data files are retrieved in chronological order.

4. The method of claim 1, wherein the desired ones of the plurality of data files are retrieved in a user-defined order.

5. The method of claim 1, wherein the subsampling of the current data file is performed at a user-defined rate.

6. The method of claim 1, wherein the subsampling of the current data file is performed at a computer-defined rate based at least in part upon properties of the current data file.

7. The method of claim 1, wherein the derived measurements include at least one of sub-waveform, sub-spectrum, cascade spectrum, and Bode/Nyquist plots.

8. An apparatus for continuous playback of machine vibration data that is stored in a plurality of data files, the apparatus comprising:
an interface module adapted to select for analysis desired ones of the plurality of data files,
an input/output module adapted to retrieve a first one of the desired data files,
a processor adapted to designate the first of the desired data files as a current data file,
the processor adapted to calculate a sequence of derived measurements based on a subsampling of the current data file,
the interface module adapted to present visualizations of the current data file and the sequence of derived measurements,
the input/output module adapted to retrieve a subsequent one of the desired data files,
the processor adapted to designate the subsequent one of the desired data files as the current data file,
the processor adapted to iteratively process all of the desired data files, and
a non-transitory computer-readable storage module adapted to store selected portions of the derived measurements.

9. The apparatus of claim 8, wherein the desired ones of the plurality of data files comprise all of the plurality of data files.

10. The apparatus of claim 8, wherein the desired ones of the plurality of data files are retrieved in chronological order.

11. The apparatus of claim 8, wherein the desired ones of the plurality of data files are retrieved in a user-defined order.

12. The apparatus of claim 8, wherein the subsampling of the current data file is performed at a user-defined rate.

13. The apparatus of claim 8, wherein the subsampling of the current data file is performed at a computer-defined rate based at least in part upon properties of the current data file.

14. The apparatus of claim 8, wherein the derived measurements include at least one of sub-waveform, sub-spectrum, cascade spectrum, and Bode/Nyquist plots.

15. A non-transitory, computer-readable storage medium having stored thereon a computer program comprising a set of instructions for causing a computer to continuously playback machine vibration data that is stored in a plurality of data files, by performing the steps of:
a) selecting for analysis desired ones of the plurality of data files,
b) retrieving a first one of the desired data files and designating the first of the desired data files as a current data file,
c) calculating a sequence of derived measurements based on a subsampling of the current data file,
d) presenting visualizations of the current data file and the sequence of derived measurements,
e) retrieving a subsequent one of the desired data files and designating the subsequent one of the desired data files as the current data file,
f) iteratively repeating steps (c), (d), and (e) until all of the desired data files have been processed, and
g) storing selected portions of the derived measurements on a non-transitory computer-readable storage medium.

16. The non-transitory, computer-readable storage medium of claim 15, wherein the desired ones of the plurality of data files comprise all of the plurality of data files.

17. The non-transitory, computer-readable storage medium of claim 15, wherein the desired ones of the plurality of data files are retrieved in chronological order.

18. The non-transitory, computer-readable storage medium of claim 15, wherein the desired ones of the plurality of data files are retrieved in a user-defined order.

19. The non-transitory, computer-readable storage medium of claim 15, wherein the subsampling of the current data file is performed at a user-defined rate.

20. The non-transitory, computer-readable storage medium of claim 15, wherein the derived measurements include at least one of sub-waveform, sub-spectrum, cascade spectrum, and Bode/Nyquist plots.
